(19) United States
(12) Patent Application Publication
(10) Pub. No.: US 2003/0163294 A1
(43) Pub. Date: Aug. 28, 2003

(54) Method for reducing the size in designing a servo system simulation program configured in a programmable calculator

(76) Inventor: Ping-Ho Chen, Hsinchu (TW)

Correspondence Address: J.C. Patents, Inc., Suite 250, 4 Venture, Irvine, CA, 92618, US

(21) Appl. No.: 10/047,663

(22) Filed: Jan. 14, 2002

(51) Int. Cl. G06G 7/62; G06F 17/50

(52) U.S. Cl. 703/13

(57) ABSTRACT

A method for reducing the size in designing a servo system simulation program configured in a programmable calculator. The method has the following steps: determining a servo type is a generalized type, and assigning servo parameters; then determining an input function as a combination function, and using a plot to display the input function; the servo type sequentially generates an output function and a state variable according to the servo parameters and the input function, and uses a plot to display the output function. Thus, the memory usage of the programmable calculator is reduced, and the programmable calculator can be applied to the simulation of the servo system.

### BACKGROUND OF THE INVENTION

1. Field of Invention

The present invention generally relates to a method for reducing the size in designing a servo system simulation program, and more particularly, to a method for reducing the size in designing a servo system simulation program configured in a programmable calculator.

2. Description of Related Art

Thanks to the advancements of the technologies, consumer electronic products have also advanced. The continuously growing purposes of the vendors of the consumer electronic products are not only to provide more functions, but also to make these products lighter, thinner, shorter, and smaller in compliance with consumer trends and economic growth.

For example, the common programmable calculator (e.g. TI, SHARP and CASIO, . . . etc) in use today supports not only +, −, ×, ÷ functions and trigonometric functions, but also supports the input of programmable logic operation equations, can calculate the required mathematic equations, and also has the capability to display a simple coordinate diagram. Addition of a simulation tool to the programmable calculator in the education market would increase its value and stimulate dramatic growth in the education market for programmable calculators.

Some difficulties exist in using a conventional programmable calculator as a simulation tool. Using the CASIO fx-6300G as an example, these problems include:

1. The difference of the Programming Language: The CASIO fx-6300G calculator only supports 400 steps for use as the standard program steps. An instruction in an assembly language or a high-level language (e.g. BASIC language) may comprise several steps.

2. The size of memory is extremely limited: The CASIO fx-6300G only supports 26 registers and it costs another 8 program steps if one extra register is used. Therefore, it is very difficult to use the limited memory of the programmable calculator to configure the simulation of the servo system.

3. Reducing the size of the “Simulation Rules” is not easy: The PC automatic control software MATLAB-SIMULINK uses the complicated Runge-Kutta Rule. Although the Runge-Kutta Rule is quite accurate, it uses a lot of memory. Thus, it is very difficult to apply it to the programmable calculator.

4. The selection of the servo type is difficult: There is no servo system simulation software that can be used as a reference in the market today, much less for application of the servo system simulation in a programmable calculator. Therefore, it is not easy to apply the input, output and the servo type of the servo system to the programmable calculator.

### SUMMARY OF THE INVENTION

The present invention provides a method for reducing the size in designing the servo system simulation program configured in a programmable calculator. In order to reduce the memory usage of the programmable calculator, the method redefines the servo types in terms of a general type and redefines the input function as a combination function. Thus, the programmable calculator can be used for servo system simulation.

The present invention uses a method to reduce the size in designing the servo system simulation program configured in the programmable calculator. The method of the present invention comprises the steps of: determining the servo type as a general type, and assigning servo parameters; then determining the input function as a combination function, and using a plot to display the input function; the servo type consequently generates an output function and a state variable according to the servo parameters and the input function, and uses a plot to display the output function. The usage of the memory in the programmable calculator is reduced, thus the programmable calculator can be applied to simulate the servo system.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 is a basic model of the preferred embodiment according to the present invention;

FIG. 2 is an engineering model of the FIG. 1;

FIG. 3A is a curve diagram of the step function;

FIG. 3B is a curve diagram of the ramp function;

FIG. 3C is a curve diagram of the function, which is a combination of the step function and the ramp function;

FIG. 4 is a flow chart according to the present invention;

FIG. 5 is the simulation results according to the present invention;

FIG. 6A is a basic model of another embodiment according to the present invention;

FIG. 6B is an engineering model of FIG. 6A;

Table 1 shows the relationship between the servo type and the steady state errors;

Table 2 shows the planning of the registers of the programmable calculator;

Table 3 shows the servo system simulation program; and

Table 4 shows the figures of the simulation results according to the present invention.

### DESCRIPTION OF THE PREFERRED EMBODIMENTS

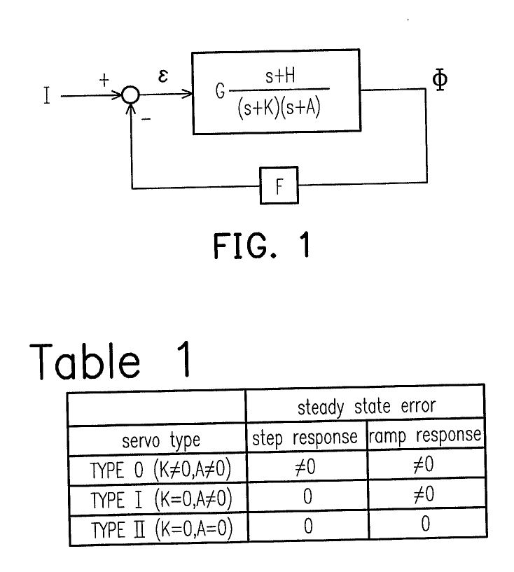

FIG. 1 shows the basic model of a preferred embodiment according to the present invention. In FIG. 1, the model is represented by the Laplace operator, wherein I represents the input Laplace function, Φ represents the output Laplace function, G represents the gain of the transfer function, A and K represent the pole parameters of the open loop transfer function, H represents the zero parameter of the open loop transfer function, and F represents the feedback value. According to the relationship between the servo type and the steady state errors shown in Table 1, the basic model includes three different servo types, i.e. TYPE 0 servo if K≠0 and A≠0; TYPE I servo if K=0 and A≠0; and TYPE II servo if K=0 and A=0. The formula of the steady state error, resulting from inputting different input functions into these three different servo types, is:

$${lim}_{t \to ∞} ϵ ( t ) = {lim}_{s \to ∞} s ϵ ( s )$$

Therefore, when the TYPE 0 servo type is applied in the basic model, both of the steady state errors are not equal to 0 if the input function is either a step function or a ramp function. When the TYPE I servo type is applied in the basic model, the steady state error is equal to 0 if the input function is a step function and the steady state error is not equal to 0 if the input function is a ramp function. When the TYPE II servo type is applied in the basic model, both of the steady state errors are equal to 0 if the input function is either a step function or a ramp function.

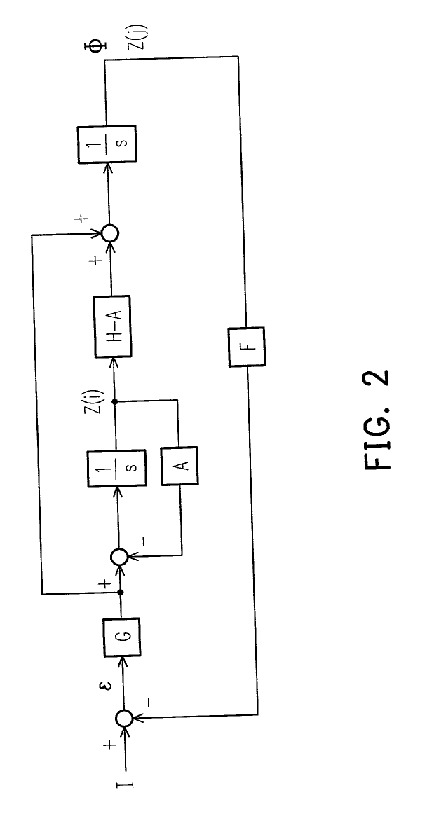

In order to efficiently reduce the memory usage of the programmable calculator (it means using the same CASIO fx-6300G model), the basic model in FIG. 1 uses the Combination Type, a combination of TYPE Φ, TYPE I, and TYPE II, to simulate the servo system. FIG. 2 is an engineering model of FIG. 1 for simulation, wherein the Z(i) and Z(j) are used to represent the state variables.

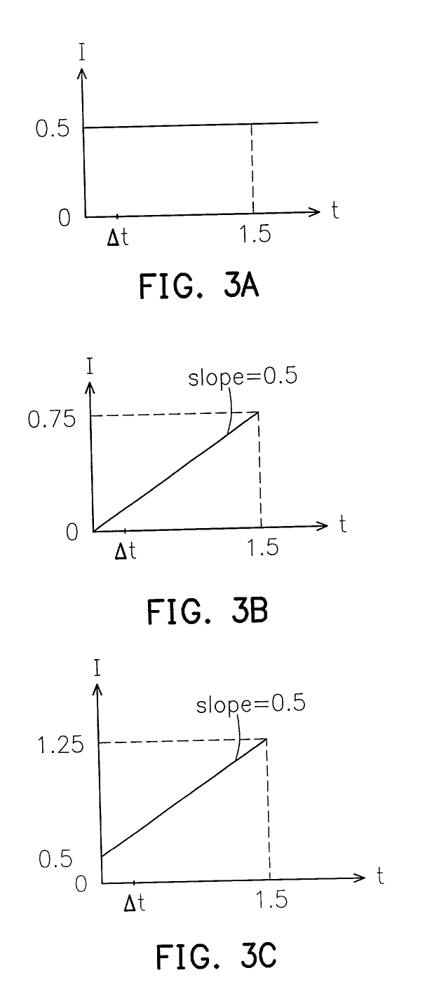

The step function and the ramp function are commonly used as an input function in the simulation of the servo system. As the curved diagram of the step function which shown in FIG. 3A, the magnitude of this step function is 0.5. As the curved diagram of the ramp function which shown in FIG. 3B, the initial point of this ramp function is 0, and the slope of this ramp function is 0.5. Δt represents the time interval in both FIG. 3A and FIG. 3B.

Similarly, in order to efficiently reduce the memory usage of the programmable calculator, a combination function that is a combination of the step function and the ramp function is used as an input function to simulate the servo system. In FIG. 3C, which shows the curved diagram of the combination function that is a combination of the step function and the ramp function, the initial point of this combination function is 0.5, and the slope is still 0.5.

The meaning of each register of the programmable calculator must be defined before the servo simulation system of the programmable calculator starts running. Table 2 shows the planning of the registers of the programmable calculator. As shown in Table 2, 11 programmable calculator registers and 30 non-programmable calculator registers are to be used. Thus, there are 240 (8×30) extra steps reduced in the programmable calculator.

Table 3 shows the program for simulating the servo system. Before the simulation of the servo system starts running, the engineering model of the servo system is written into the calculator using the given programming language, and uses the registers that planned in Table 2 to store the figures that are calculated out. The program in Table 3 uses 150 instruction steps and 41 registers. In addition to the original 30 extra used registers that use 240 extra steps correspondingly. The total number of the equivalent step used is 390.

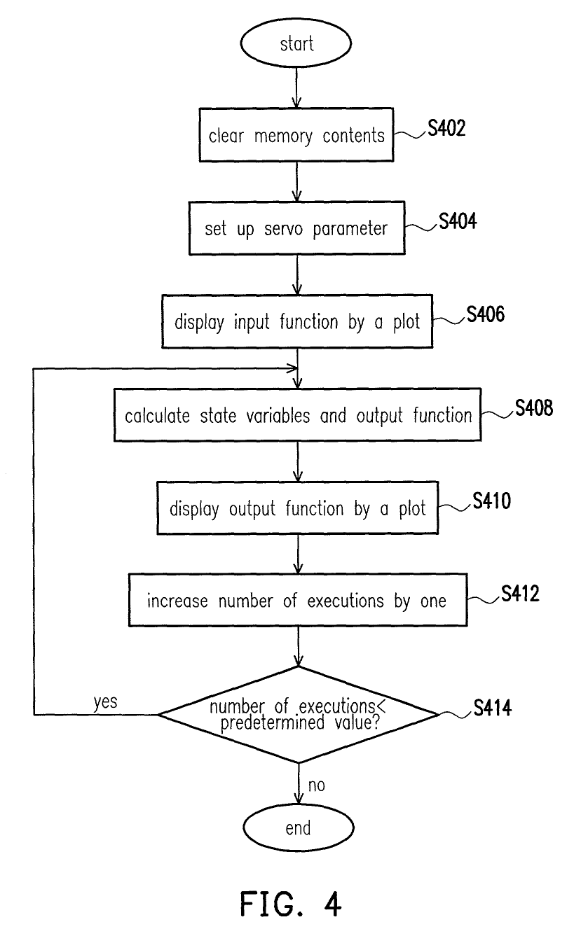

FIG. 4 shows the flow chart according to the present invention. In order to acquire the largest amount of the memory space to be used in the simulation of the servo system, the contents of the programmable calculator memory is cleared before the simulation of the servo system starts running (S402).

The servo type of the servo system is consequently determined. The servo type that uses the engineering model in FIG. 2 as an example uses the engineering model of the general type that is a combination of the TYPE I loop function and the TYPE II loop function. Then, based on this engineering model, the servo parameters as shown in Table 3 are set up: the input function type, the pole parameters, the feedback value and the increase value of the time interval, . . . etc. The input function is a combination function that is a combination of the step unction and the ramp function as shown in FIG. 3C (S404).

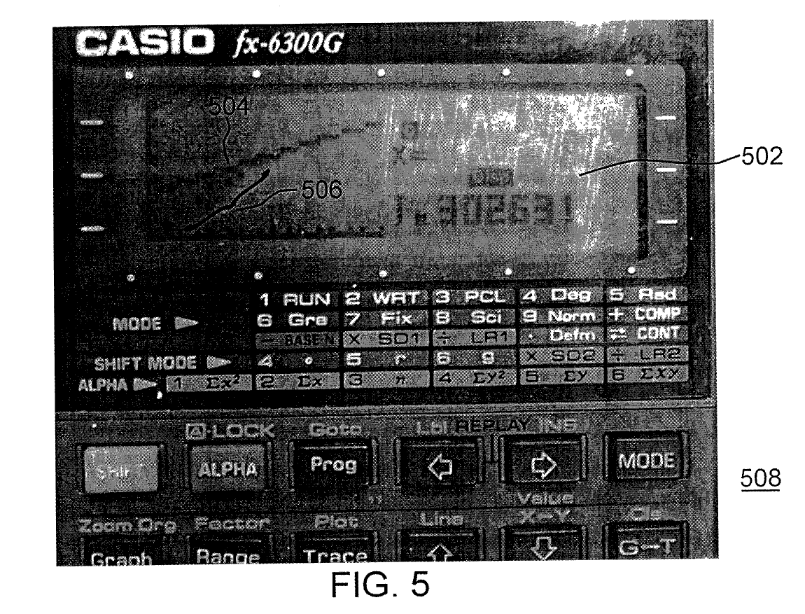

The curve of the input function is then displayed by using a plot after setting the type of the input function (S406). FIG. 5 shows the simulation results, as shown in the diagram, the curve 504 which shown in the screen 502 of the calculator 508 is the curve of the input function.

The program of Table 3 is then used to simulate the servo system. The state variables Z[C] and Z[C+16] (that corresponds to the Z(i) and Z(j) as shown in Table 2) are generated from the simulation (S408). After the calculation, the figures of the output function are displayed as a curve diagram of the function (S410). As shown in FIG. 5, the curve 506 shown in the screen 502 of the calculator 508 is the curve of the output function.

The number of the executions is increased by one after each time interval. The program in Table 3 simulates the servo system, calculates out the figures of the state variables and the output function, and displays the figures of the output function as a curve diagram (S412). Then the program determines whether the number of executions is less than a predetermined value (the predetermined values used in this embodiment is 15) (S414). If the number of executions is less than the predetermined value, the program recursively returns to step S408, running the step of calculating the figures of the state variables and the output function. If the number of the executions is greater or equal to the predetermined value, the simulation of the servo system is terminated.

Table 4 shows the figures of the simulation results according to the present invention. In Table 4, Δt represents the time interval of the servo simulation, Z(i) and Z(j) represent the state variables, wherein Z(j) is also an output function, I/P represents the input function. One of the simulation results of the engineering model in FIG. 2 is the figures of Z(j), which are displayed as the curve 506 in the screen 502 as shown in the FIG. 5. (The figure Z(j) represented by ‘*’ indicates that the calculator is running out of memory to store the figures of the calculated results.) Therefore, the calculator can be used to simulate the servo system for educational purposes.

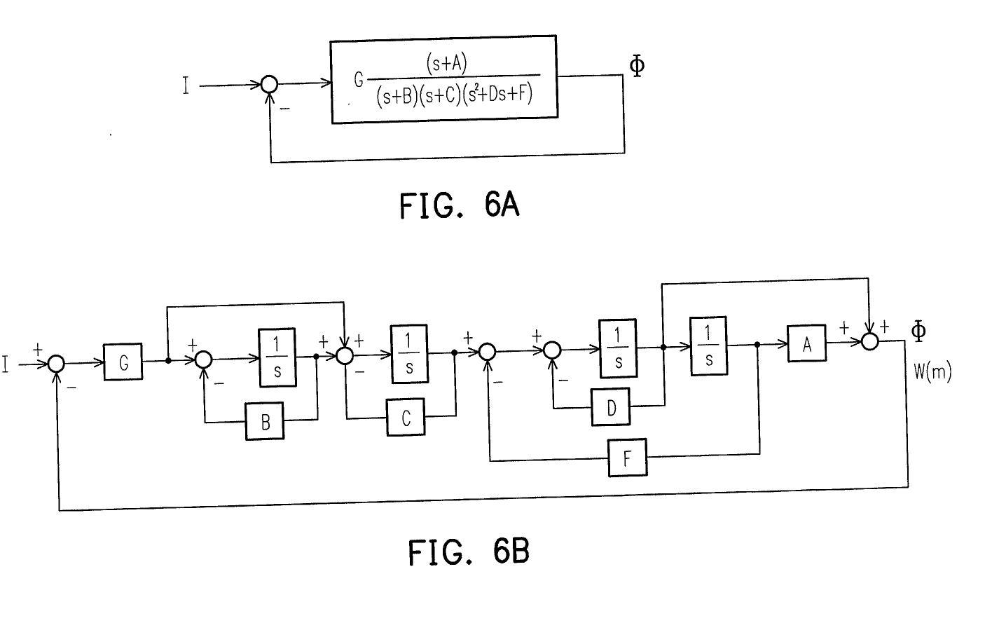

In all the descriptions above, the more complicated servo system can be simulated when CASIO or other vendors develop a calculator having the larger amount of the memory size. This can be seen from FIG. 6A that shows the basic model of another embodiment according to the present invention, and from FIG. 6B, which shows an engineering model of FIG. 6A. Thus, the calculator can be used to simulate the servo system for educational purposes.

The advantages of the present invention are the redefinition of the servo type as a generalized type, redefine the input function as a combination function, to reduce the memory usage of the programmable calculator and thus to apply the calculator using the simulation of the servo system.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims and not by the above detailed description.

TABLE 2

| | |
|---|---|
| A: | the pole of the open loop transfer function |
| B: | ramp slope of the input function |
| C: | counter |
| D: | time interval |
| E: | multiply value of the error G |
| F: | feedback value |
| G: | the gain of the open loop transfer function |
| H: | the zero of the open loop transfer funtion |
| I˜W: | blank |
| X: | time variable of the input function |
| Y: | input function |
| Z: | Z(0) |
| Z(i): | value of state 1, i = 1˜15 |
| Z(j): | value of state 2, j = 16˜30 |

TABLE 3

CLS: MCL: 1.7 → G: ? → B: ? → H: Graph Y = 0.5 + B * X:
1 → F: .1 → D: .2 → A:
Lbl 2: Defm30:
(.5 + B * D * C − F * Z[C + 16]) * G → E_{▴}
Z[C] (E − A * Z[C]) * D → Z[C + 1]_{▴}
Z[C + 16] + (Z[C] + E) * (H − A) * D → Z[C + 17]_{▴}
Plot C ÷ 10, Z[C + 16]_{▴}
I_{SZ} C_{▴} Gøtø2:

TABLE 4

| t | 0.1 | 0.2 | 0.3 | 0.4 | 0.5 | 0.6 | 0.7 | 0.8 | 0.9 | 1.0 | 1.1 | 1.2 | 1.3 | 1.4 |
|---|---|---|---|---|---|---|---|---|---|---|---|---|---|---|
| Z(i) | 0.085 | 0.153 | 0.205 | 0.246 | 0.276 | 0.298 | 0.313 | 0.323 | 0.329 | 0.332 | 0.332 | 0.328 | 0.325 | 0.321 |
| Z(i) | 0.153 | 0.290 | 0.412 | 0.522 | 0.621 | 0.710 | 0.79 | 0.865 | 0.934 | 0.998 | 1.059 | 1.170 | 1.223 | * |
| I/P | 0.5 | 0.55 | 0.6 | 0.65 | 0.7 | 0.75 | 0.8 | 0.85 | 0.9 | 0.95 | 1.00 | 1.10 | 1.15 | 1.20 |

What is claimed is:

1. A method for reducing a size in designing a servo system simulation program configured in a programmable calculator, the method comprising the steps of:
determining a servo type as a generalized type and assigning servo parameters;
determining an input function as a combination function and displaying the input function by using a plot;
the servo type generating an output function and a state variable according to the servo parameter and the input function; and
displaying the output function by using a plot.

2. The method of claim 1, wherein the method determines the servo type is a type of a Laplace transfer function.

3. The method of claim 2, wherein the method determines the servo type to be a Laplace transfer function and the generalized type is a combination of TYPE 0, TYPE I, and TYPE II servo in the open loop transfer function.

4. The method of claim 1, wherein the combination function is a combination of a step function and a ramp function.

5. The method of claim 1, wherein the step of displaying the output function using the plot further comprises the steps of:
increasing a number of executions by one; and
determining whether the number of executions is a predetermined value;
wherein if the number of the executions is not equal to the predetermined value, the program returns to a step where the servo type generates the output function and the state variable according to the servo parameters and the input function.

6. The method of claim 5, wherein the method further includes the step of: before the servo type generates the output function and the state variables again by using the servo parameters and the input function, the servo type uses the state variable generated out in the previous calculation as the state variable to be used this time to calculate the output function.
